(19) United States
(12) Patent Application Publication
(10) Pub. No.: US 2015/0039374 A1
(43) Pub. Date: Feb. 5, 2015

(54) PLANNING PERIODIC INSPECTION OF GEO-DISTRIBUTED INFRASTRUCTURE SYSTEMS

(71) Applicant: International Business Machines Corporation, Armonk, NY (US)

(72) Inventors: Dung T. Phan, Ossining, NY (US); Yada Zhu, Irvington, NY (US)

(73) Assignee: International Business Machines Corporation, Armonk, NY (US)

(21) Appl. No.: 13/957,496

(22) Filed: Aug. 2, 2013

(51) Int. Cl. G06Q 10/06; G06Q 10/00

(52) U.S. Cl. CPC G06Q 10/06313; G06Q 10/20
USPC 705/7.23

(57) ABSTRACT

An optimization framework to find the periodic inspection interval over an infinite time horizon for geo-distributed infrastructure systems subject to hidden failures. The unit's failure can only be rectified at periodic inspection, at which point a failed unit will be considered as being “perfectly” repaired. For geo-distributed infrastructure systems, for example, fire hydrants in a city, water and power supply networks in urban areas, firstly, the units of a system are clustered into groups. Then, the optimal inspection interval is calculated for each group based on the expected cost per cycle. Finally, the best schedule for inspection is determined. This schedule: (i) minimizes the global system inspection and maintenance cost; and (ii) meets the applicable labor and budget resource constraints. An integer nonlinear programming formulation together with a heuristics deals with the inspection schedule.

### FIELD OF THE INVENTION

The present invention relates generally to the field of geo-distributed infrastructure systems, and more particularly to inspection of geo-distributed infrastructure systems.

### BACKGROUND OF THE INVENTION

It is currently conventional to build infrastructure systems and to periodically inspect them. It is known to consider unit level long-term operating cost (that is, renewal reward) when determining the appropriate schedule for these inspections.

The reliability of infrastructure systems in urban areas and its associated social impacts, such as inoperable fire hydrants and power outage, is a recognized problem. With the availability of geographic information systems and computer-based asset management systems, some municipalities have started to collect infrastructure reliability data and plan proactive maintenance interventions. Proactive maintenance can be classified as condition-based maintenance (CBM) and preventive maintenance (PM).

CBM is performed when an indicator of the condition of the system reaches a predetermined level. One of the three main tasks of CBM is to monitor the condition indicator and assess the current system condition from measured data. CBM is understood to be expensive and is limited in application by its expense.

PM is carried out at predetermined time intervals which are conventionally estimated based on historical data, failure time distributions of the systems, and economic or availability models. In practice, PM is still the most common maintenance policy applied to repairable systems. When a system is maintained at unequal time intervals, the PM policy is known as sequential PM.

### SUMMARY

According to an aspect of the present invention, a method includes the following steps (not necessarily in the following order): (a) determining optimal inspection time intervals for a plurality of clusters of geo-distributed infrastructure units; and (ii) determining an inspection schedule for each cluster of the plurality of clusters based upon at least one of the following factors: (i) minimization of global system and maintenance cost, (ii) imposing the inspection frequency close to the optimal inspection interval, (iii) maintaining minimum reliability requirements, and (iv) satisfying labor and budget resource constraints. At least the determination of the inspection schedule is performed by computer software running on computer hardware.

### BRIEF DESCRIPTION OF THE SEVERAL VIEWS OF THE DRAWINGS

FIG. 1 is a schematic view of a first embodiment of a networked computer system according to the present invention;

FIG. 2 is a flowchart showing a process performed, at least in part, by the first embodiment computer system;

FIG. 3 is a schematic view of a portion of the first embodiment computer system;

FIG. 4 is a diagram showing organization of clusters according to the present invention.

### DETAILED DESCRIPTION

This Detailed Description section is divided into the following sub-sections: (i) The Hardware and Software Environment; (ii) First Embodiment; (iii) Further Comments and/or Embodiments; and (iv) Definitions and Variable Definition List.

### I. The Hardware and Software Environment

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

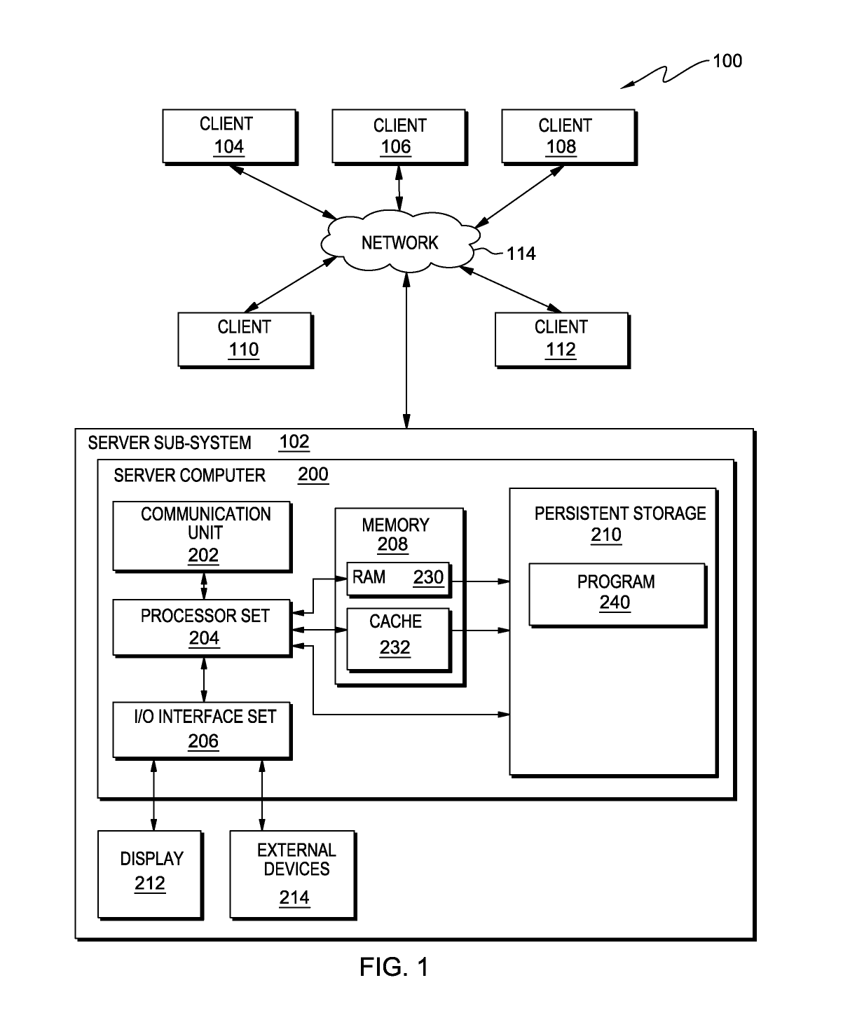

An embodiment of a possible hardware and software environment for software and/or methods according to the present invention will now be described in detail with reference to the FIG. 1. FIG. 1 is a functional block diagram illustrating various portions of distributed data processing system 100, including: server computer sub-system (that is, a portion of the larger computer system that itself includes a computer) 102; client computer sub-systems 104, 106, 108, 110, 112; communication network 114; server computer 200; communication unit 202; processor set 204; input/output (i/o) interface set 206; memory device 208; persistent storage device 210; display device 212; external device set 214; random access memory (RAM) devices 230; cache memory device 232; and program 240.

As shown in FIG. 1, server computer sub-system 102 is, in many respects, representative of the various computer sub-system(s) in the present invention. Accordingly, several portions of computer sub-system 102 will now be discussed in the following paragraphs.

Server computer sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 240 is a collection of machine readable instructions and/or data that is used to create, manage and control certain software functions that will be discussed in detail, below, in the Operation of the Embodiment(s) sub-section of this Detailed Description section.

Server computer sub-system 102 is capable of communicating with other computer sub-systems via network 114 (see FIG. 1). Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

It should be appreciated that system 100 provides only an illustration of one implementation and does not imply any limitations with regard to the environments in which different embodiments may be implemented. Many modifications to the depicted environment may be made, especially with respect to current and anticipated future advances in cloud computing, distributed computing, smaller computing devices, network communications and the like.

As shown in FIG. 1, server computer sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 240 is stored in persistent storage 210 for access and/or execution by one or more of the respective computer processors 204, usually through one or more memories of memory 208. Persistent storage 210: (i) is at least more persistent than a signal in transit; (ii) stores the device on a tangible medium (such as magnetic or optical domains); and (iii) is substantially less persistent than permanent storage. Alternatively, data storage may be more persistent and/or permanent than the type of storage provided by persistent storage 210.

Program 240 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102, such as client sub-systems 104, 106, 108, 110, 112. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 240, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

### II. First Embodiment

Preliminary note: The flowchart and block diagrams in the following Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

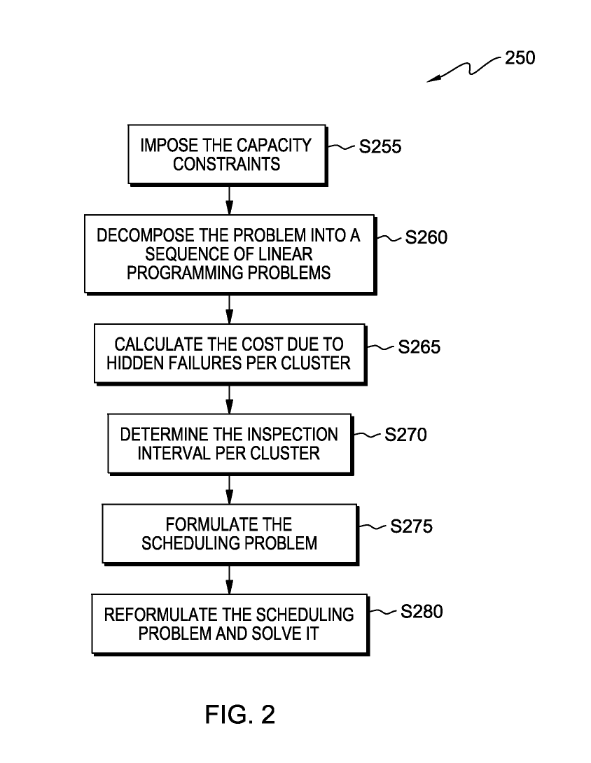

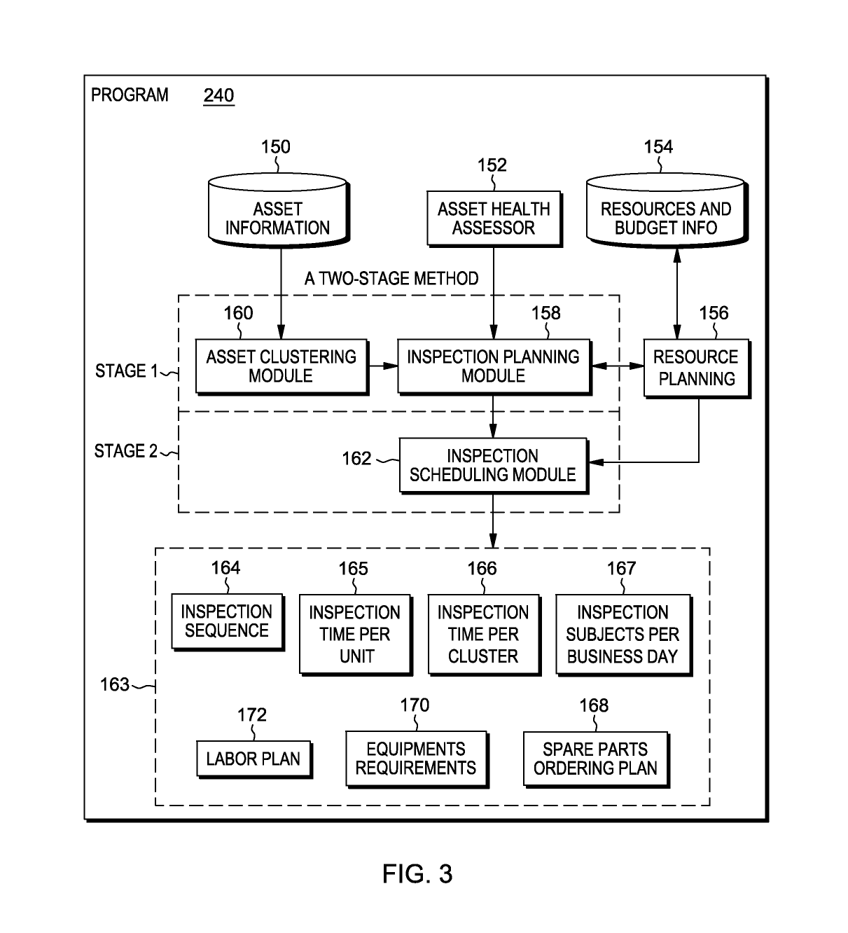

FIG. 2 shows a flow chart 250 depicting a method according to the present invention. FIG. 3 shows program 240 for performing at least some of the method steps of flow chart 250. This method and associated software will now be discussed, over the course of the following paragraphs, with extensive reference to FIG. 2 (for the method step blocks) and FIG. 3 (for the software blocks).

In “first stage” processing, geo-distributed infrastructure units (or, simply, units; for example, fire hydrants) are grouped into clusters and then an inspection time interval (or, simply, inspection interval) is calculated for each cluster on a cluster-by-cluster basis. More specifically, first stage processing begins at step S255 where asset clustering module 160 and asset information data store 150 work together co-operatively to group the system-wide units into multiple clusters. In this embodiment, step 255 includes imposing the maximum and minimum number of units that can be inspected during a given scheduling interval in determining the clusters. In this embodiment, equations that can be used to determine the cluster groupings also account for: (i) mutual geographic proximity of the constituent units of the cluster; (ii) the maximum and minimum number of units that are permitted in a single cluster; and inspection capacity constraints for geo-distributed infrastructure units. The following is a typical example of an inspection capacity constraint: each inspection takes at least two hours, and each day a group of technicians only can perform four inspections. Alternatively, or additionally, other factors may be considered in determining equations for grouping the clusters, such as: water pressure level in hydrant system; load history in the power system; arbitrary political subdivisions; minimization of road closures; other kinds of service interruptions; etc.

Processing proceeds to step S260 where module 160 takes the integer nonlinear clustering problem generated by step S255, decomposes the integer nonlinear programming into a sequence of linear programming problems, and solves the linear programming problems to fully determine the cluster groupings.

Processing proceeds to step S265 where inspection planning module 158 (working in co-operation with asset health assessor module 152, resources and budget information data store 154 and resource planning module 156) calculates the cost due to hidden failures per cluster. “Hidden failure” refers to a failure that can only be detected upon inspection. Sometimes, before inspection, the unit will have already failed but this failed status is not known until inspection.

Processing proceeds to step S270 where module 158 determines the optimal inspection time interval per cluster (also expressible as an inspection frequency) based on the failure cost data determined at step S265. This ends the first stage processing, where clusters are determined and their respective inspection intervals are determined.

After step S270, “second stage” processing begins. In second stage processing, an inspection schedule is determined, where the geo-distributed infrastructure units are scheduled for inspections on a cluster-by-cluster basis. More specifically, processing proceeds to step S275 where inspection scheduling module 162 (with the co-operation of resource planning module and resources and budget information data store 154) formulates the scheduling problem by formulating scheduling equations which consider at least the following factors: (i) minimization of global system and maintenance cost; (ii) imposing the inspection frequency close to the optimal inspection interval; (iii) maintaining minimum reliability requirements (for example, a typical minimum reliability requirement for fire hydrants is the minimum number of inspections during a given time horizon); and (iv) satisfying labor and budget resource constraints. Alternatively, some embodiments may use only some of the foregoing factors. As a further alternative, some embodiments may also use additional factors, now known or to be developed in the future.

Regarding factor (i) in the previous paragraph, a system cost is different than a maintenance cost because the global system cost includes the repair cost if failures occur and the penalty cost for the elapsed time from a failure to its detection at the next inspection.

With respect to factor (ii) set forth two paragraphs above, in this embodiment, module 162 is programmed to impose different penalties for the deviations from the optimal inspection intervals. An example of a penalty will be discussed in more detail, below, in connection with equation (7a) (specifically parameter β). Different penalty term values are assigned for different inspection time interval deviations. For example, if an inspection earlier than the optimal time interval is performed, a smaller penalty value is assigned than that which would be assigned for a delayed inspection. In this embodiment, inspections always occur at axed time interval. Alternatively, in other embodiments, due to some constraints (such as labor availability) a schedule based on the fixed interval may not be rigidly followed. As an example, of this kind of possible “play” in the scheduling, if a great number of clusters would ideally be scheduled for inspection on the same day, then some of the inspections might be postponed and/or performed early. A way of calculating the time interval in the final schedule is discussed in more detail, below, in connection with equations (7).

With respect to factor (iv) set forth three paragraphs above, a typical example of a labor resource requirement is a limit on the number of technical teams that can do inspection work. A budget resource constraint depends on the associated projected cost of an activity and a typical example would be a constraint that mandates that during a month, there is no more than $10,000.00 that will be spent for inspection activities.

Processing proceeds to step S280 where module 162 reformulates the scheduling problem, from the original formulation obtained at step S275, and solves the reformulated problem. More specifically, in this embodiment, the original formulation takes the form of an integer non-linear programming problem, but the reformulation is a continuous non-convex non-linear problem (these aspects will be further discussed below in the Further Comments and/or Embodiments sub-section of this Detailed Description section). Even more specifically, in this embodiment, the non-convex problem formulation of step S275 is gradually transformed from a strictly convex problem. The solution from the previous problem acts as a starting point for the next one, and eventually end a solution of the original problem is obtained.

Further at step S280, the final inspection schedule is output to output data store 163 (including inspection sequence portion 164, inspection time per unit portion 165, inspection time per cluster portion 166, inspection subjects per business day portion 167, labor plan portion 172, equipments requirements portion 170 and spare parts ordering plan portion 168).

### III. Further Comments and/or Embodiments

Some embodiments of the present disclosure recognize that for management and maintenance of large-scale geo-distributed repairable systems, the basic cost to transport equipment, technicians and spare parts from one place to another can be the largest contributor to the total maintenance cost. In light of this, some embodiments of the present disclosure provide an optimization framework to find a periodic inspection interval over a time horizon (for example, an infinite time horizon) for geo-distributed infrastructure systems subject to hidden failures. The geo-distributed components are clustered into groups based on their attributes and/or connectivity. This can reduce the logistics cost for PM (preventive maintenance). Then, the optimal periodic inspection interval for each cluster is determined with respect to minimal expected cost per cycle. Finally, given the optimal inspection interval, the best inspection schedule is determined considering the resource constraints and the inspection cost. Some embodiments of the present disclosure include a nonlinear optimization algorithm to solve the scheduling problem.

The problem descriptions and some operative assumptions will be discussed. Consider a large-scale infrastructure system with geo-distributed units. The units are subject to hidden failures. The objective is to determine the periodic inspection interval for each unit of the system with minimum maintenance cost and operative constraints. Some embodiments of the present disclosure make the following assumptions: (i) the k^{th} cluster of units is inspected at times tᵢ^{k}; (ii) failures are only rectified and repaired at periodic inspections; (iii) a penalty cost is applied to the elapsed time from a failure to its detection at the next planned inspection; (iv) the inspection is perfect and PM is performed if no failure is detected; (v) a unit is “good-as-new” after either an inspection or a repair; (vi) inspection and repair times are negligible; and (vii) the lifetime distributions of all units are known or can be estimated based on historical data.

Some embodiments of the present disclosure provide an optimization framework for planning of periodic inspection of repairable systems with geo-distributed units. This framework consists of three parts as follows: (i) the system is portioned into a number of clusters; the optimal periodic interval for each cluster is determined; and (iii) an optimal inspection schedule given the workforce and budget constraints is introduced.

Units clustering will now be discussed. For infrastructure systems with units distributed over a large geographical area, the logistic cost to transport equipment, technicians and spare parts for maintenance activities can be a relatively large contributor to the total cost. To reduce such cost, a set of |N| units is partitioned into |K| disjoint groups (that is, clusters), and scheduling is based upon the periodic inspection for each disjoint cluster. The k-means algorithm is one of the most powerful tools for clustering vector-based data. Each unit (or point) is characterized by a number of features such as the geographical measures and ages of units. The algorithm aims to maximize the similarities between points in the same cluster, which is achieved by minimizing the total distances between all points from their respective centroids. Given a set of points {p1, . . . , p_{|N|}}, where each point is a d-dimensional real vector, the classical clustering problem can be expressed as the following optimization problem of equations (1a), (1b) and (1c):

$$\begin{matrix}{min}_{x , w} g ( x , w ) = {\sum }_{i = 1}^{\vert N \vert} {\sum }_{j = 1}^{\vert K \vert} {w}_{ij} {‖ {x}_{j} - {p}_{i} ‖}_{2}^{2} & ( 1 a ) \\ s . t . {\sum }_{j = 1}^{\vert K \vert} {w}_{i , j} = 1 , i = 1 , … , \vert N \vert , & ( 1 b ) \\ {w}_{ij} ∈ \{ 0 , 1 \} , i = 1 , … , \vert N \vert , j = 1 , … , \vert K \vert , & ( 1 c )\end{matrix}$$

where xⱼ is the centroid of the j-th cluster and wᵢⱼ=1 if the point pᵢ is assigned to the j-th cluster. One shortcoming of the above formulation is that it might lead to either empty clusters or clusters with very few points. One possible way to address the problem is using the constraint that the number of points j in a cluster is fixed. This constraint is shown by equation (2):

$${\sum }_{i = 1}^{\vert N \vert} {w}_{ij} = {n}_{j} , j = 1 , … , \vert K \vert . \qquad ( 2 )$$

Another possible constraint on cluster size requires the lower bounds lⱼ on the cluster sizes, which imposes the following constraints of equation (3):

$${l}_{j} \leq {\sum }_{i = 1}^{\vert N \vert} {w}_{ij} , j = 1 , … , \vert K \vert . \qquad ( 3 )$$

These formulations are NP-hard mixed-integer nonlinear programs, and the alternating minimization algorithm based on the divide and conquer technique, originated from a known algorithm for clustering without size constraints, can be used to solve them. It makes use of the fact that there is no coupling constraint between variables x and w in the feasible set. This “clustering algorithm” is carried out in two steps as follows: (i) for fixed x̂(k), g(x̂(k),w) is minimized over w subject to equations (1b), (1c) and either equation (2) or equation (3) to get ŵ(k+1); and (ii) for fixed ŵ(k+1), g(x,ŵ(k+1)) is minimized over x to get x̂(k+1).

It has been shown that the algorithm converges in a finite number of iterations. In some embodiments of the present invention, it is desired to consider the upper bound uᵢ on each cluster size because of the workforce availability constraint. Some embodiments of the present disclosure include the following constraint of equation (4):

$${l}_{j} \leq {\sum }_{i = 1}^{\vert N \vert} {w}_{ij} , {u}_{j} , j = 1 , … , \vert K \vert . \qquad ( 4 )$$

The new constraints generalize all three cases mentioned above. The iterative algorithm is applied, and the finite convergence still holds. The sub-problem arising from Step (i) of the clustering algorithm when the constraint of either equation (2) or equation (3) is replaced by equation (4) is an integer linear programming, whose complexity does not significantly increase comparing to the original ones. It can be efficiently solved by some MILP (Mixed-integer linear programming) solvers such as CPLEX. The solution from Step (ii) of the clustering algorithm has a simple closed form as shown by the following equation (5):

$${x}_{j}^{( k + 1 )} = \frac{{\sum }_{i ∈ N} {( {w}_{ij} )}^{( k + 1 )} {p}_{i}}{{\sum }_{i ∈ N} {( {w}_{ij} )}^{( k + 1 )}} , j ∈ K \qquad ( 5 )$$

Optimal periodic inspection planning will now be discussed. In this embodiment, given a cluster, the optimal inspection interval is determined over an infinite time horizon based on the renewal-reward theorem. With this theorem, the objective function is formulated as the expected cost per cycle. The expected cost is calculated as the sum of the expected cost of all the units in the cluster. The expected cost of a unit consists of three parts as follows: (i) the inspection and PM cost; (ii) the repair cost if failure occurs to a unit; and (iii) the penalty cost for the elapsed time from a failure to its detection at the next inspection. The expected cycle time is given by the sum of the inspection interval and expected unavailable time due to repair. The inspection interval, τₖ is: (i) subject to an upper bound maxτₖ (maxτₖ is set forth in equations below as τₖ with a bar over the “τ” symbol); and (ii) determined by minimizing the following objective function denominated as equation (6):

$$min \frac{1}{{τ}_{k} + u {\sum }_{i = 1}^{{n}_{k}} {F}_{i} ( {τ}_{k} \vert {t}_{o}^{k} )} [ {C}_{1} {n}_{k} + {C}_{2} {\sum }_{i = 1}^{{n}_{k}} {F}_{i} ( {τ}_{k} \vert {t}_{o}^{k} ) + {C}_{3} [ {τ}_{k} {n}_{k} + u {\sum }_{i = 1}^{{n}_{k}} {F}_{i} ( {τ}_{k} \vert {t}_{o}^{k} ) - {\sum }_{i = 1}^{{n}_{k}} {\int }_{{t}_{o}^{k}}^{{τ}_{k}} {tf}_{i} ( t ) d t ] \\ s . t . 0 \leq {τ}_{k} \leq {τ}_{k} . \qquad ( 6 )$$

The objective function of problem (6) is a nonlinear function with one decision variable. Some efficient global optimization algorithms such as DIRECT (Dividing Rectangles) and MCS (multilevel co-ordinate search), which do not require gradient information, can be used to solve the problem.

Optimal inspection schedule determination will now be discussed. In some embodiments, one objective is to minimize the total inspection cost for all clusters and impose the inspection frequency close to the optimal inspection time interval τₖ: as given by equation (7a) to (7e) as follows:

$$\begin{matrix}{min}_{{t}_{i}^{k}} φ ( t ) = {\sum }_{i ∈ I , k ∈ K} {t}_{i}^{k} {C}_{1} {n}_{k} + {\sum }_{{i}_{1} , {i}_{2} ∈ I , k ∈ K : {i}_{2} > {i}_{1}} {β}_{{i}_{1} , {i}_{2} , k} {t}_{{i}_{1}}^{k} {t}_{{i}_{2}}^{k} ( 1 - {t}_{{i}_{1} + 1}^{k} ) … ( 1 - {t}_{{i}_{2} - 1}^{k} ) \vert {i}_{2} - {i}_{1} - {τ}_{k} \vert + {\sum }_{i ∈ I , k ∈ K} {β}_{i , k} {t}_{i}^{k} ( 1 - {t}_{1}^{k} ) … ( 1 - {t}_{i - 1}^{k} ) \vert i - {τ}_{k}^{0} - {τ}_{k} \vert & ( 7 a ) \\ s . t . {\sum }_{i ∈ I} {t}_{i}^{k} \geq {r}_{k} , ∀ k ∈ K & ( 7 b ) \\ {\underline{h}}_{i} \leq {\sum }_{k ∈ K} {t}_{i}^{k} \leq {\overline{h}}_{i} , ∀ i ∈ I & ( 7 c ) \\ {\sum }_{k ∈ K} {t}_{i}^{k} {C}_{1} {n}_{k} \leq {\overline{b}}_{i} , ∀ i ∈ I & ( 7 d ) \\ {t}_{i}^{k} ∈ \{ 0 , 1 \} , ∀ i ∈ I , ∀ k ∈ K , & ( 7 e )\end{matrix}$$

The first term in the objective function of equation (7a) is the total cost of inspections, the second and third terms are aggregate deviations between scheduled inspection times and the optimal ones weighted by a positive scalar β. The constraint of equation (7b) is the minimum number of inspection constraint for the k-th cluster and the equation (7c) is the labor availability condition. Note that both the lower and upper bounds on hᵢ are allowed to be zero (0) for some iεI which represent non-business periods. The constraint of equation (7d) is the budget constraint for time period iεI. This is implemented by large-scale integer non-convex nonlinear programming, where the numbers of units |K| and time periods |I| are typically at least a few tens. It may be difficult for state-of-the-art exact MINLP (Mixed Integer Nonlinear Programming) solvers to solve problems of these sizes to optimality in some embodiments of the present invention because of the large running time and large amount of memory needed. Therefore, some embodiments of the present invention use a scalable heuristic approach to solving problem (7).

Because a concave function attains its optimal minimizer at an extreme point of the feasible set, the discrete problem (7) can be transformed into equivalent continuous nonlinear programming as shown by equations (8a) to (8c) as follows:

$$\begin{matrix}{min}_{{t}_{i}^{k}} {ψ}_{ρ} ( t ) = φ ( t ) + ρ {\sum }_{i ∈ I , k ∈ K} {t}_{i}^{k} ( 1 - {t}_{i}^{k} ) & ( 8 a ) \\ s . t . ( 7 b ) , ( 7 c ) , ( 7 d ) & ( 8 b ) \\ 0 \leq {t}_{i}^{k} \leq 1 , ∀ i ∈ I , ∀ k ∈ K , & ( 8 c )\end{matrix}$$

For a sufficiently large ρ>0. However, as p increases, so does the number of local minimizers of the problem (8). As a result, it might lead to a low solution quality for any local search method if there is not a sufficiently good starting point, which is expected to be close to the global optimal solution. A homotopy method can be used to obtain a good initial guess. The main concept is that the method starts by first solving a strictly convex problem, whose optimal solution does not depend on a starting point and is unique, and, then, gradually deforms the convex problem into a non-convex problem. The solution from the previous problem acts as a starting point for the next one, and the method eventually ends with a solution of the original problem. The same technique to produce the homotopy affect can be achieved by the deformation of ρ for the polynomial of higher degree φ(t).

The following has been proved and will herein be referred to as Theorem 1:

(i) There exists a constant maxρ such that if ρ>maxρ then problem (7) and problem (8) are equivalent.

(ii) There exists a constant minρ such that if ρ<minρ then ψₚ(t) is strictly convex on [0, 1].

(iii) Because φ(t) is a polynomial, the smallest eigenvalue of ∇²φ(t) over the compact set [0, 1] exists and is finite, which is denoted by ρₘᵢₙ; taking ρ=ρₘᵢₙ/2 implies that ∇²ψ_{ρ}(t) is positive definite for any ρ<minρ, which completes the proof.

The above theorem suggests that it may be helpful to increase ρ iteratively from a small value to get the homotopy trajectory. The algorithm for solving optimization problem (8) is given by the homotopy algorithm set forth in the following paragraph.

Homotopy algorithm:

1. Initialize t⁽⁰⁾, ρ⁽⁰⁾, δ₁>0, δ₂>1
2. For n=1, 2, . . .
(a) Solve the following starting from t⁽ⁿ⁾ to get t⁽ⁿ⁺¹⁾
   minₜψ_{ρ(n)}(t)
   s.t. (7b), (7c), (7d) (S)
   0≦tᵢ^{k}≦1, ∀iεI,∀kεK.
(b) Terminate the algorithm if a stopping criteria is satisfied, but, otherwise, go to Step 2c.
(c) If ρ⁽ⁿ⁾≦0 then set ρ⁽ⁿ⁺¹⁾=ρ⁽ⁿ⁾+δ1, else set ρ⁽ⁿ⁺¹⁾=ρ⁽ⁿ⁾δ2.

Some first-order algorithms with warmstarting capability using only primal solution information such as active-set methods and projection gradient algorithms can be utilized to solve problem (S). One known homotopy method for solving the MINLP with linear constraints will now be briefly explained. A logbarrier term −τ(ln(t)+ln(1−τ)) is added to the objective to globally smooth and convexify it, where τ>0 is a smoothing factor that balances the strictly convex log-barrier with the original objective function. For a large value of the smoothing factor τ, the problem is strictly convex and has a unique solution. Note that the optimal solution of the sub-problem for ρ sufficiently large is located at a vertex of the unit hypercube 0≦x≦1, the log-terms ln(tᵢ^{k})+ln(1−tᵢ^{k})) will make it difficult to apply gradient-based methods. Therefore, second order methods should be used, but they cannot easily take advantage of an advanced starting point obtained from a related problem.

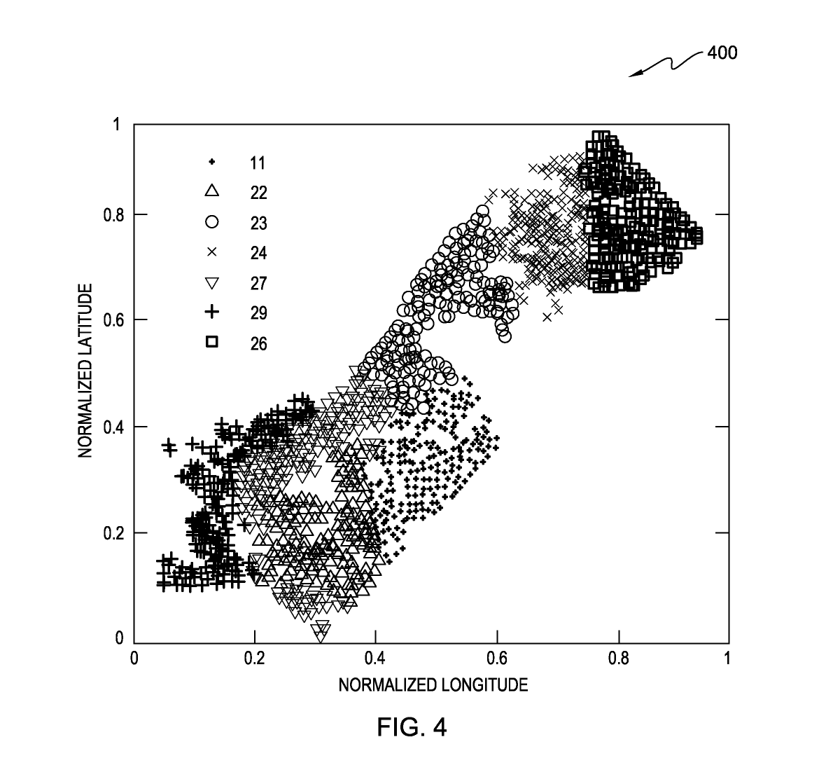

An example case study will now be discussed with reference to Tables 1 and 2 (below) and FIG. 4. In this case study, proposed optimization framework is applied to plan and schedule the inspection of fire hydrants in a major U.S. city over a year. For safety reasons, fire hydrants are subject to periodic inspections. Based on the inspection results, hydrants that have failed or are in poor condition are either repaired or replaced. There are total |N|=10803 hydrants in the city. For the optimization framework, we identify |KI|=50 hydrant clusters from the aforementioned clustering algorithm where the bounds in equation (4) are defined by the following equation set (9):

$${l}_{k} = ⌊ ( 1 - 0.01 ) \frac{\vert N \vert}{\vert K \vert} ⌋ , and {u}_{k} = ⌊ ( 1 + 0.01 ) \frac{\vert N \vert}{\vert K \vert} ⌋ \qquad ( 9 )$$

Equation set (9) is for all kεK. The time interval AI is a week, so there are |I|=52 weeks in the numerical simulation of this embodiment. In FIG. 4, diagram 400 shows the graphical results for 7 clusters where the geographical attributes and water pressure levels are considered. The geographical attributes include the longitude and latitude of each hydrant. The pressure level reflects information such as water demand, population density, and residential or commercial consumers, etc. In this example, the value for β is 0.1. The values for τₖ⁰ minhᵢ and maxhᵢ are randomly chosen. The value for the minimum inspection times rₖ is selected as follows: if n−0.3<(365−τₖ⁰*ΔI)/τₖ≦n+0.7 then rₖ=n.

In the homotopy algorithm, t⁽⁰⁾=1, ρ⁰=−1000, δ1=100, δ2=1.5 and the algorithm is terminated according to the following inequality:

$${max}_{i ∈ I , k ∈ K} {( {t}_{i}^{k} )}^{( n )} ( 1 - {( {t}_{i}^{k} )}^{( n )} ) \leq 1 e - 3$$

First, a state-of-the-art MINLP solver, namely KNITRO (Nonlinear Interior point Trust Region Optimization) version 8.1, is used to solve problem (7) for different settings on the number of clusters and time intervals so as to validate the solution quality and running time of the heuristic approach set forth herein. It is an NLP-based branch and bound algorithm, and is exact when φ is convex. However, in this embodiment, φ is non-convex; thus KNITRO serves for heuristic purposes as well. In this embodiment, the homotopy algorithm is implemented in AMPL (A Mathematical Programming Language) modeling language and uses the active-set method from KNITRO to solve the sub-problem (S). Table 1, set forth below, reports the performance in terms of the computed optimal function value (opt), the number of inspections (# insp), and the running time (time) in seconds. The optimal function values for this approach (denoted by “HOMO”) and KNITRO are very comparable. The proposed method yields all most the same solution quality with those obtained from the global technique. The algorithm of this embodiment is able to solve for problems with practical sizes. Table 1 follows:

| | | | | KNITRO | | | HOMO | | |
|---|---|---|---|---|---|---|---|---|---|
| Cases | | | # | | # | | | # | |
| \|K\| | \|I\| | ΔI | Var | opt | insp | time | opt | insp | time |
| 10 | 12 | 30 | 120 | 8.8 | 25 | 0.38 | 8.7 | 25 | 2.05 |
| 15 | 12 | 30 | 180 | 12.3 | 27 | 0.82 | 12.3 | 27 | 5.62 |
| 20 | 12 | 30 | 240 | 163 | 52 | 249.41 | 16.9 | 53 | 16.13 |
| 20 | 26 | 14 | 520 | 19.2 | 57 | 6223.1 | 19.5 | 57 | 81.42 |
| 30 | 26 | 14 | 780 | failed | | | 26.1 | 82 | 175.21 |
| 50 | 52 | 7 | 2600 | failed | | | 48.1 | 138 | 2426.5 |

Table 2 gives the inspection schedule for 7 clusters depicted in diagram 400 of FIG. 4:

| Cluster Index | τk | 0th | 1st | 2nd | 3rd | 4th |
|---|---|---|---|---|---|---|
| 11 | 21 | 0 | 21 | 42 | — | — |
| 22 | 14 | −9 | 5 | 19 | 33 | 47 |
| 23 | 24 | −11 | 13 | 36 | — | — |
| 24 | 13 | −1 | 12 | 25 | 38 | 49 |
| 26 | 18 | −3 | 15 | 33 | 51 | — |
| 27 | 26 | −9 | 17 | 43 | — | — |
| 29 | 20 | −18 | 3 | 23 | 43 | — |

In most cases, the clusters obey the optimal inspection time requirement, that is, the inspection intervals are equal to τk. Because of the workforce limitation for periods, some inspections deviate from the optimal values for a few time units, but are still close to the suggested values.

Some embodiments of the present disclosure provide an optimization framework for solving the periodic inspection interval over an infinite time horizon for large-scale geo-distributed infrastructure systems. In particular, an integer nonlinear programming model and associated heuristics to solve the problem have been developed. Some embodiments of the present disclosure lay a foundation for sustainable resource management.

Some embodiments of the present invention may include one, or more, of the following features, characteristics and/or advantages: (i) a two-stage method and system for determining the periodic inspection for infrastructure systems consisting of geo-distributed units that are subject to hidden failures; (ii) a clustering module to partition the set of units based on the geographical information and other available asset attributes that explicitly considers the number of units in each cluster and preserves inspection capacity constraints for geo-distributed units; (iii) a planning module to compute the inspection interval for each cluster based on the expected cost per inspection interval for units subject to hidden failures; (iv) a scheduling module to determine the schedule for each cluster that: (a) minimizes the global system inspection and maintenance cost, (b) imposes the inspection frequency close to the optimal inspection interval, (c) maintains the minimum reliability requirements, and/or (d) satisfies the labor and budget resource constraints; (v) leverages geo information; (vi) utilize clusters to control the size of the periodic inspection problem; (vii) considers the problem of inspection frequency and impose it close to the optimal inspection interval; (viii) determines the optimal inspection interval based on the expected cost per inspection interval (ix) obtains the best compromised inspection schedule under the constraints of cost, reliability requirements, labor, etc.; (x) a method to plan and schedule the time and labor to perform infrastructure inspection actions; and/or (xi) leverages geo information and utilizes clusters to control the size of the periodic inspection problem.

### IV. Definitions and Variable Definition List

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Software storage device: any device (or set of devices) capable of storing computer code in a manner less transient than a signal in transit; “software storage device” does not include: any device that stores computer code only as a signal; and/or a signal propagation media, such as a copper cable, optical fiber or wireless transmission media.

Tangible medium software storage device: any software storage device (see Definition, above) that stores the computer code in and/or on a tangible medium.

Computer: any device with significant data processing and/or machine readable instruction reading capabilities including, but not limited to: desktop computers, mainframe computers, laptop computers, field-programmable gate array (fpga) based devices, smart phones, personal digital assistants (PDAs), body-mounted or inserted computers, embedded device style computers, application-specific integrated circuit (ASIC) based devices.

Variable Definition List follows:
I the set of time intervals;
N the set of units;
K the set of unit clusters;
tᵢ^{k}=1 if the k-th cluster of units is inspected at i-th time, =0 otherwise;
τₖ the optimal inspection time interval for the k-th cluster of units;
τₖ⁰ k the most recent time to do inspection for the k-th cluster of units;
τ̅ₖ is the upper bound of τₖ;
tₖ⁰ the age of a unit at the time of planning;
u the expected unavailable time if any repair action occurs in a cluster of units;
rₖ the minimum number of times to do inspection for the k-th cluster of units;
h̅ᵢ the maximum number of inspection actions for the i-th interval;
hᵢ the minimum number of inspection actions for the i-th interval;
b̅ᵢ the maximum budget for the i-th interval; β the penalty parameter for the optimal time interval;
nₖ the number of units in the k-th cluster;
C₁ inspection and preventive maintenance cost per unit;
C₂ repair cost per unit;
C₃ penalty cost per unit time if a failure occurs before the next planned inspection time to a unit;
F(·|·) conditional CDF (cumulative density function) of failure time;
f(·) PDF (probability density function) of failure time.

What is claimed is:

1. A method comprising:
determining optimal inspection time intervals for a plurality of clusters of geo-distributed infrastructure units; and
determining an inspection schedule for each cluster of the plurality of clusters based upon at least one of the following factors: (i) minimization of global system and maintenance cost, (ii) imposing the inspection frequency close to the optimal inspection interval, (iii) maintaining minimum reliability requirements, and (iv) satisfying labor and budget resource constraints;
wherein:
at least the determination of the inspection schedule is performed by computer software running on computer hardware.

2. The method of claim 1 wherein the determination of the inspection schedule is based upon, at least, all of the following factors: (i) minimization of global system and maintenance cost, (ii) imposing the inspection frequency close to the optimal inspection interval, (iii) maintaining minimum reliability requirements, and (iv) satisfying labor and budget resource constraints.

3. The method of claim 1 wherein the determination of the inspection schedule includes the following:
formulating a scheduling formulation as an integer nonlinear programming problem;
re-formulating the integer form scheduling formulation as a continuous non-convex problem; and
solving the non-convex problem to yield the inspection schedule.

4. The method of claim 1 further comprising:
partitioning a plurality of geo-distributed infrastructure units into the plurality of clusters of infrastructure resource units based upon, at least: geographical information and other asset attributes, that explicitly considers the number of units in each cluster and preserves inspection capacity constraints.

5. The method of claim 1 wherein the determination of the inspection schedule includes:
imposing a maximum and minimum number of geo-distributed infrastructure units subject to inspection during a predetermined time interval in the form of integer programming; and
decomposing the integer programming into a sequence of linear programming.

6. The method of claim 1 wherein the determination of the inspection schedule includes imposition of penalties based upon the size of discrepancies between scheduled inspection intervals and the optimal inspection intervals.

7. A computer program product comprising software stored on a software storage device, the software comprising:
first program instructions programmed to determine optimal inspection time intervals for a plurality of clusters of geo-distributed infrastructure units; and
second program instructions programmed to determine an inspection schedule for each cluster of the plurality of clusters based upon at least one of the following factors: (i) minimization of global system and maintenance cost, (ii) imposing the inspection frequency close to the optimal inspection interval, (iii) maintaining minimum reliability requirements, and (iv) satisfying labor and budget resource constraints;
wherein:
the software is stored on a software storage device in a manner less transitory than a signal in transit.

8. The product of claim 7 wherein the determination of the inspection schedule is based upon, at least, all of the following factors: (i) minimization of global system and maintenance cost, (ii) imposing the inspection frequency close to the optimal inspection interval, (iii) maintaining minimum reliability requirements, and (iv) satisfying labor and budget resource constraints.

9. The product of claim 7 wherein the second program instructions include the following:
third program instructions programmed to formulate a scheduling formulation as an integer nonlinear programming problem;
fourth program instructions programmed to re-formulate the integer form scheduling formulation as a continuous non-convex problem; and
fifth program instructions programmed to solve the non-convex problem to yield the inspection schedule.

10. The product of claim 7 further comprising:
third program instructions programmed to partition a plurality of geo-distributed infrastructure units into the plurality of clusters of infrastructure resource units based upon, at least: geographical information and other asset attributes, that explicitly considers the number of units in each cluster and preserves inspection capacity constraints.

11. The product of claim 7 wherein the second program instructions include:
third program instructions programmed to impose a maximum and minimum number of geo-distributed infrastructure units subject to inspection during a predetermined time interval in the form of integer programming; and
fourth program instructions programmed to decompose the integer programming into a sequence of linear programming.

12. The product of claim 7 wherein the second program instructions include third program instructions programmed to impose penalties based upon the size of discrepancies between scheduled inspection intervals and the optimal inspection intervals.

13. A computer system comprising:
a processor(s) set; and
a software storage device;
wherein:
the processor set is structured, located, connected and/or programmed to run software stored on the software storage device; and
the software comprises:
first program instructions programmed to determine optimal inspection time intervals for a plurality of clusters of geo-distributed infrastructure units; and
second program instructions programmed to determine an inspection schedule for each cluster of the plurality of clusters based upon at least one of the following factors: (i) minimization of global system and maintenance cost, (ii) imposing the inspection frequency close to the optimal inspection interval, (iii) maintaining minimum reliability requirements, and (iv) satisfying labor and budget resource constraints.

14. The system of claim 13 wherein the determination of the inspection schedule is based upon, at least, all of the following factors: (i) minimization of global system and maintenance cost, (ii) imposing the inspection frequency close to the optimal inspection interval, (iii) maintaining minimum reliability requirements, and (iv) satisfying labor and budget resource constraints.

15. The system of claim 13 wherein the second program instructions include the following:
third program instructions programmed to formulate a scheduling formulation as an integer nonlinear programming problem;
fourth program instructions programmed to re-formulate the integer form scheduling formulation as a continuous non-convex problem; and
fifth program instructions programmed to solve the non-convex problem to yield the inspection schedule.

16. The system of claim 13 further comprising:
third program instructions programmed to partition a plurality of geo-distributed infrastructure units into the plurality of clusters of infrastructure resource units based upon, at least: geographical information and other asset attributes, that explicitly considers the number of units in each cluster and preserves inspection capacity constraints.

17. The system of claim 13 wherein the second program instructions include includes:
third program instructions programmed to impose a maximum and minimum number of geo-distributed infrastructure units subject to inspection during a predetermined time interval in the form of integer programming; and
fourth program instructions programmed to decompose the integer programming into a sequence of linear programming.

18. The system of claim 13 wherein the second program instructions include third program instructions programmed to impose penalties based upon the size of discrepancies between scheduled inspection intervals and the optimal inspection intervals.
